(19) United States
(12) Patent Application Publication
(10) Pub. No.: US 2008/0178256 A1
(43) Pub. Date: Jul. 24, 2008

(54) System and method providing policy based control of interaction between client computer users and client computer software programs

(76) Inventors: Brian Perrone, Nashville, TN (US); Dalton Franklin, Nashville, TN (US)

Correspondence Address: Brian Perrone, Suite 301, 2505 21st Ave. South, Nashville, TN, 37212, US

(21) Appl. No.: 12/008,635

(22) Filed: Jan. 14, 2008

Related U.S. Application Data
(60) Provisional application No. 60/881,806, filed on Jan. 23, 2007.

(51) Int. Cl. G06F 17/00; G06F 3/048

(52) U.S. Cl. 726/1; 715/764

(57) ABSTRACT

A system and method for creating, maintaining and enforcing an authorized system state through the use of policies that prohibit and/or authorize both the writing and execution of executable files is presented. Executable code that is attempting to execute is intercepted and suspended by a kernel-level file filter driver. A file signature is used to uniquely identify the executable code file at time of execution. Policies either allow the file to execute, prohibit the file from executing, allow the file to write executable code to disk while recording all file write activity conducted, prohibit the file from writing executable code to disk, or are created at the time of execution by prompting administrators to establish policy for the file.

This application claims priority from provisional application No. 60/881,806 filed Jan. 23, 2007.

### FIELD OF THE INVENTION

This invention relates generally to networked client computers, and more particularly to controlling the interaction between entities logged on to client computers and applications on a client computer.

### BACKGROUND OF THE INVENTION

Basic application control, defined as having the capability to intercept operating system kernel-level system calls as applications are launched and compare them to a managed list to determine if an application should be run or not, may provide benefits to information technology administrators which could include reduced support costs, application access policy enforcement, and increased productivity.

The two primary approaches to basic application control are white list (policy is authorized) and black list (policy is prohibited), each of which limits execution according to the list: Accordingly, white listed applications can run—black listed applications may not run. Both approaches increase administrative overhead for information technology administrators by forcing them to manage the lists. Both approaches fail to prevent the writing of executable code to disk, fail to provide the level of granularity needed by information technology administrators to create and enforce application use policy in a scalable manner, and fail to provide a scalable methodology for processing exceptions to policy.

A network administrator for an organization faces numerous challenges in both enforcing application access policy and preserving the integrity of installed, authorized applications. Client computer connectivity to the Internet particularly makes the prevention of the installation and execution of unauthorized applications a nearly impossible challenge. It would be beneficial to be able to provide application control in a system that not only prevents the execution of unauthorized executable code, but also prevents the writing of unauthorized executable code to disk in a scalable framework for applying policy to authorized files written to disk either as the result of an exception to policy, or as an authorized installation.

### SUMMARY OF THE INVENTION

One or more client computers are connected through a network to a management console, web server, database server and system server that communicates with the client computer in real time. The client computer and management console exchange information. The client computer reports identifying information such as machine identifier, user identifier, and application inventory to the administration console. The administration console communicates configuration settings and policy behavior settings to the client computer.

Users of client computers and client computers themselves are organized into roles. Executable files are organized into file groups. The intersection of file groups and roles determines policy for file execution and file write permissions. Therefore, a user on client computer and a client computer itself are either authorized or prohibited to execute files according to the intersection of the role in which the user of client computer or client computer itself intersects with the file group in which the file resides. Likewise, a file is either authorized or prohibited from writing executable code to disk. If policy is not explicit for the role/file group intersection, an exception to policy process may be initiated, depending upon the configuration of the policy system. In the exception process, a request ticket is generated by the user and routed to the policy exception manager for the user or computer. In cases where the request is simply to execute a file, the user's exception manager is notified for an authorization decision. In cases where the request is to install software, the computer's exception manager is notified for an authorization decision to install software. In either case, only the authorization to write executable code to the computer's file system will enable the file to modify the contents of executable code on the computer.

A file filter driver running on the client computer monitors and intercepts all application requests to execute in the operating system of the client computer and passes those requests to a policy engine on the client computer for processing before application execution is permitted. The file filter driver passes an application identifier to the policy engine which computes the request to execute for policy. In one aspect, files in file groups authorized for a given role are authorized to execute. In another aspect, files in file groups prohibited for a given role are denied execution. In still a further aspect, all other attempts to execute are processed in the solution for exceptions to policy. Exceptions to policy are initiated when policy is not explicitly stated for a request to execute. Likewise, files with permissions to write executable code to disk are permitted to do so. All others are prevented from writing executable code to disk.

The results of the writing of executable files to disk either as a result of an exception to policy or as a result of an explicitly authorized application are tracked, recorded and automatically assigned policy based on the circumstances and context of the activity. In one aspect, executable files written to disk as a result of an exception to policy are selectively configured for automated file grouping. In another aspect, executable files written to disk as a result of an existing policy are automatically grouped in file groups.

The client computer also passes information about application execution activity to the management console which stores the information in a data repository for reporting and analysis.

The present invention describes systems, clients, servers, and methods of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a diagram of one embodiment of an operating environment suitable for practicing the present invention

FIG. 2 is a flowchart of policy evaluation methods to be performed by a client computer, server, and administration console according to an embodiment of the invention;

FIG. 3 is a diagram illustrating a system-level overview of an embodiment of the invention;

### DETAILED DESCRIPTION OF THE DRAWINGS

Non-limiting and non-exhaustive embodiments of the present invention are described with reference to the following figures, wherein like reference numerals refer to like parts throughout the various views unless otherwise specified.

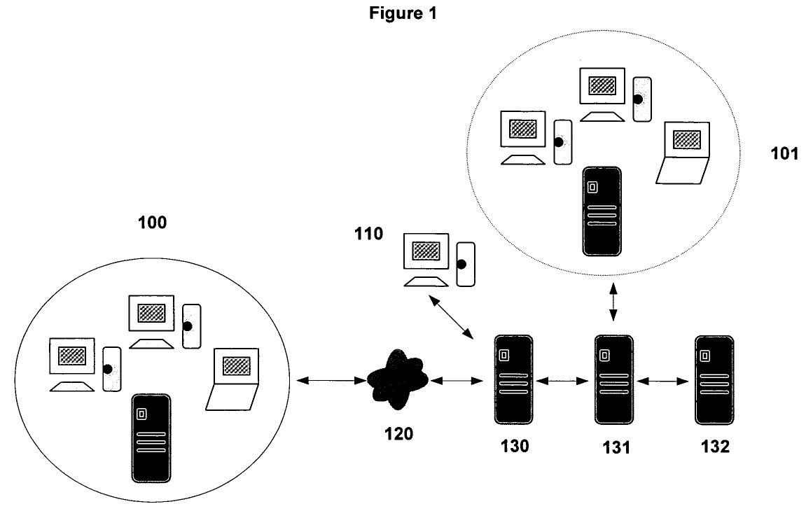

One embodiment of an operating environment suitable for practicing the present invention is described by reference to FIG. 1. As shown in FIG. 1, one or more computers 100 exiting outside the internal network of an organization and installed with the system policy control agent and service communicate with the system web application server 130 via the Internet 120. One or more computers 101 existing inside the internal network of an organization communicate directly with the system web application server 130 via the organization's internal network. The system web application server 130 communicates directly with the system policy server 131 and system policy data store 132 via the organization's internal network.

The system web application server 130 generates web pages containing the Hypertext Text Markup Language (HTML). The content of these web pages is accessed from the policy system administration console 110 and are generated when policy related activity takes place. Policy activity includes, but is not limited to, the creation, management and configuration of roles, file groups, users, user groups, machines, machine groups, system administrators, policies, and all specific events that transpire within the system for these items in the form of reports.

Policy system control agents collect information about installed executable code on computers 100 and 101, store this information on local databases and transmit this information through the system policy server 131 to the policy system data store 132. The information collected and/or computed includes, but is not limited to, installed executable fine names, the paths representing their installed location, computed file signature hashes, file author information, and file version. Collection of this information is performed either as the result of a scan of the computer, or as the result of a user initiated request to install or run executable code on the computer. The policy system server 131 deploys and maintains policies governing the installation and use of executable code on computers. Polices are created when a file as part of a file group maintained by the policy system server 131, is either authorized or prohibited for a given role. Administration of policies is conducted from the policy system administration console 110 which directs specific policy requests to system administrators.

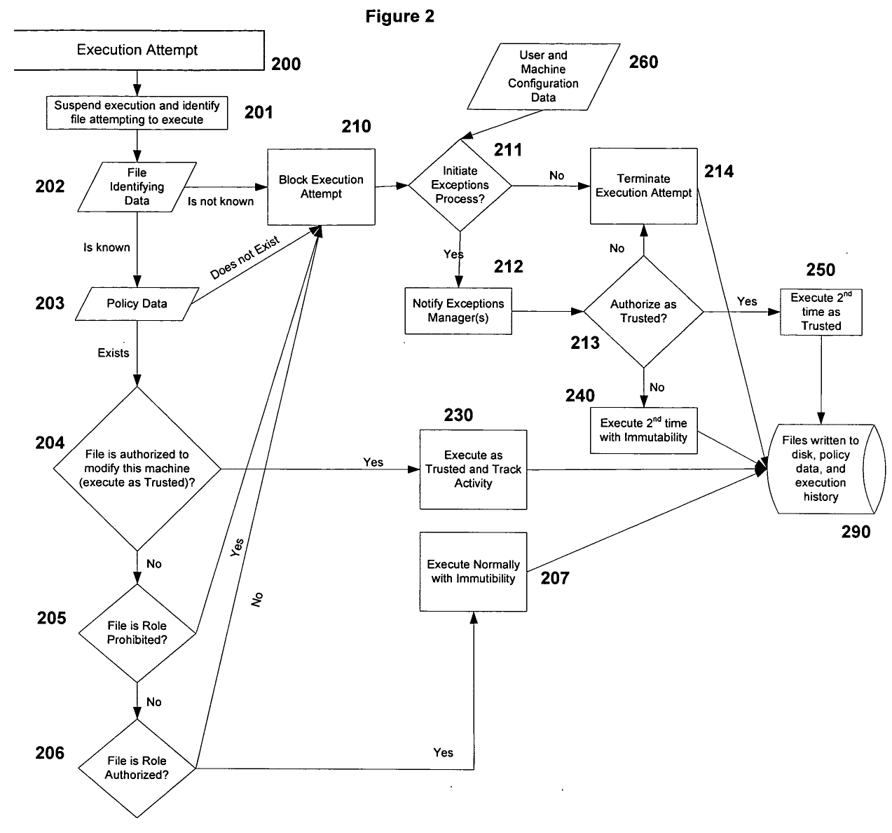

FIG. 2 is a flowchart of methods to be performed by the policy system according to an embodiment of the invention.

A user of a client computer initiates an execution attempt 200 which is suspended 201 in the kernel of the operating system by the kernel-level file filter driver of the control agent and processed for identification of its file signature hash. The method checks the local data store for a match of file identifying data 202. If a match exists (the file is known), the method then checks for policy data 203 which has been transmitted and synchronized from the policy system server. If policy data 203 exists (a policy has been created), the method then checks if the policy data allows for the file to modify 204 (write, edit, delete) executable code on the computer. If the file is not authorized to modify executable code on the computer, the method then checks if the file is prohibited to execute for the role 205 (role prohibited) in which it was initiated for execution. If the file is not role prohibited, the method then checks if the file is authorized for the role 206 in which it was initiated for execution (role authorized). If the file is role authorized, the control agent instructs the kernel to allow the file to execute normally 207 without the ability to modify executable code on the computer (execute with immutability). A record of the successful execution is stored 290 in the policy system data store and policy is automatically established for that file.

If, in the above, the file identifying data 202 is not known, execution is blocked 210 by the policy system control agent. The method then checks configuration data 260 (stored in the local data store; synchronized with the policy system server) if the user or computer (machine) has permissions 211 to initiate requests for exceptions to policy. If permissions exist, a user interface prompt allows a request form to be completed and notification is sent 212 to the exceptions manager of the user or machine. If the exceptions manager ignores the request, execution continues to be blocked. If the exceptions manager denies the request, the execution attempt continues to be blocked and policy is recorded. If the exceptions request is approved, the method then checks if the file has been approved to modify 213 executable code on the computer (authorized as trusted). If the file is authorized as trusted, the method then allows the user to execute the file a second time 250 and all file activity (modifications of executable code) are tracked and recorded 290 in the policy system data store. Policies for the resulting file modifications are automatically established for the modified files. If the file is authorized to only execute with immutability a second time 240, the method then allows the file to be executed a second time without permissions to modify executable code to disk. A record of the policy exception is stored 290.

If, in the above, the method applied to the first execution attempt indicates the file is authorized to modify 204 executable code on the computer, the file executes as trusted 230 (able to modify executable code) and all file activity are tracked and recorded 290 in the policy system data store. Policies for the resulting file modifications are automatically established for the modified files.

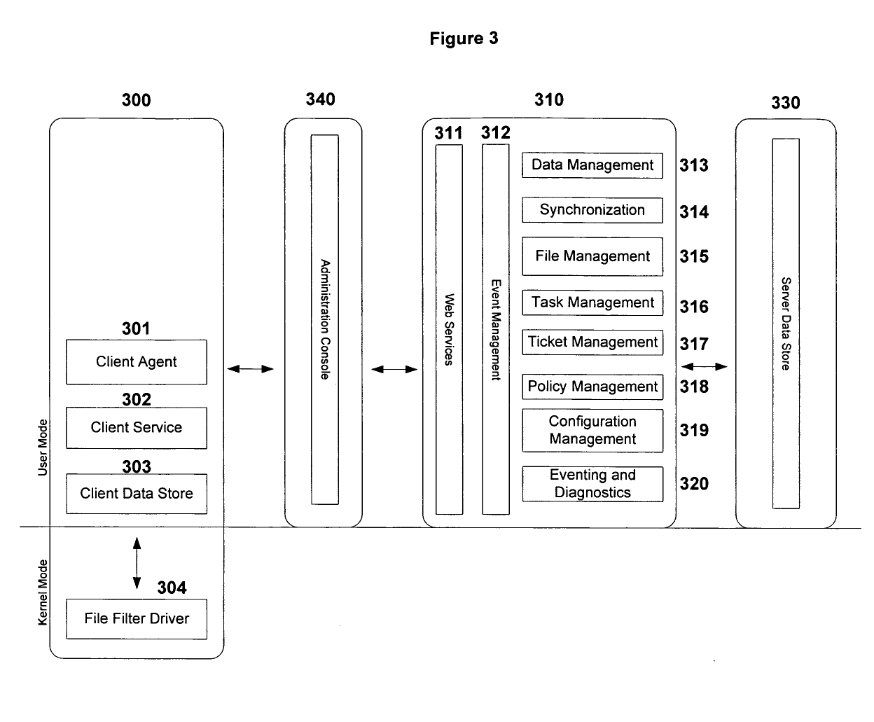

A system level overview of the operation of an embodiment of the invention is described by reference to FIG. 3.

As shown in FIG. 3, the complete policy system is comprised of three primary components supported by a data store. The client component 300, containing both user and kernel mode modules, safeguards client computers from unauthorized execution and modification of executable code. The server component 310 centralizes policy and configuration of the solution. The administration component 340 provides administrators with the ability to configure and manage the solution remotely via a web browser. In order to insure the availability of data, configuration, and rules to facilitate intelligent application control, the three components are supported by a server data store 330.

System level component modules invented for client computers 300 provide direct execution control. This component includes four primary modules. The client agent 301 (control agent) intercepts requests to access the file system in kernel mode. The client service 302 observes intercepted file system accesses, evaluates policy, directs the behavior of the driver 304, and communicates with the policy system server 310. The Client Data Store 303 provides persistent storage, in-memory caching, and access to policy, auditing, request, and configuration data. After execution is intercepted by the file system filter driver 304, (running in kernel mode alongside other low-level components of the computer operating system), the driver issues a request to the service 302 about the identified file, which then evaluates policy rules and directs the behavior of the driver. Policy rules are synchronized between the client component 300 and server component 310, which are in turn authorized by administrators through the administration console 340.

Connected clients (computers that use an organization's internal network) communicate with the policy server using a remoting channel through the client service 302. These clients transmit optimized data chunks in a binary format. Disconnected clients (computers that are outside an organization's internal network) can also communicate with the policy server using the web service 311 module. Web services module allows the administration console 340 to reside on the other side of a firewall from the policy server, and still be able to communicate using a single HTTP Port. Encrypted communications can be employed to safeguard policy, audit, and request communications.

Policy server component 310 combines multiple modules to create a facilitating server. Event management module 312 provides a mechanism that allows other modules to register their interest for certain events with the event management module. Examples of the many possible events include, but are not limited to: new file detected, client configuration changes (applied from the administration console 340), and execution prohibited.

Data management module 313 provides an in-memory object database optimized to ensure that policy and decision making occurs rapidly. Data Management manages lists and persistence of objects inside the policy server data store 330.

Synchronization module 314 is a lower level queuing module allowing changes to be queued up and sent to the server/client as a block of changes. This helps optimize the communications and minimize the amount of communication between the policy server and client computer. Logic within this component manages the object flux state, such that when a change is detected, a timer is used to ensure that all relevant change to the object have been completed before it is synchronized.

File management module 315 manages file groups and their member files and file groups. File Management enables the logical grouping of files. It also provides a location for intermediate storage during scanning for newly detected files before they are persisted.

Task management module 316 contains schedulers that are used to help optimize the internal work flow of operations, as well as provide the means for scheduling operations (and/or cascading operations based on the completion of a task). For example, during computer scans to identify installed executable code, task management module builds a tree of scheduled tasks that includes the top level scan-client task, as well as child tasks for each mount point on the machine. As the mount point tasks are completed, additional tasks are created for persisting the data. Once all the tasks are done, another task is used to synchronize the new scan results with the policy server.

Ticket management module 317 provides for the management of the various policy exception requests such that the requests are tracked and managed both on the policy server and the client computer. This module ensures that only one pending request is pending at a time for any given executable. It also ensures that administrator attention is given to the pending policy exception requests.

Policy management module 318 aggregates all policies and ensures that each client computer has the appropriate policies present. Policy management module attaches to any new file event and ensures that all policies needed for any executable file are queued for transport to the client computer.

Configuration management module 319 manages specific configurations for the clients and policy servers. This module reads configuration data from the data store and ensures that all client computers have the latest configuration information as needed.

Eventing and diagnostics module 320 is an internal support module assisting in policy system troubleshooting. This module ensures system health by collecting information from other modules that may indicate policy system performance degradation.

What is claimed is:

1. A computerized method for creating, applying and enforcing application execution permissions (policy) to client computers and users of client computers comprising: detecting, intercepting, and suspending an application execution request from an application; examining an application execution policy record to determine if the application is authorized to execute by comparing an identifier for the application with identifiers in the application policy record; allowing execution according to the policy record; tracking and recording the results of authorized execution requests; and tracking and recording executable files written to disk by authorized application execution.

2. The method of claim 1 further comprising: detecting, intercepting, and suspending an application execution request from an application; examining an application execution policy record to determine if the application is prohibited to execute by comparing an identifier for the application with identifiers in the application policy record; blocking execution according to the policy record; tracking and recording the results of blocked execution requests; and preventing the writing of executable code to disk by any unauthorized applications or processes.

3. The method of claim 1 further comprising: detecting, intercepting, and suspending an application execution request from an application; examining an application execution policy record to determine if the application is neither authorized nor prohibited to execute by comparing an identifier for the application with identifiers in the application policy record; suspending execution according to the policy record; tracking and recording the results of suspended execution requests; processing the execution request for exception to policy; tracking and recording the results of authorized execution requests resulting from exceptions to policy; and tracking and recording executable files written to disk by authorized application execution resulting from exceptions to policy.

4. The method of claim 3 further comprising: updating the application policy record by means of (a) logic that establishes network communications between a server computer, client computer, or a plurality of client computers with control agents wherein the control agents are adapted for collecting information relating to application policy; (b) logic for collecting the information from the control agents of the client computers utilizing the network for identifying similar policy activity across a subset of the plurality of client computers; and (c) logic for transmitting a response to the control agents of the server computer, client computer and/or each of the plurality of client computers utilizing the network; (d) wherein the control agents are adapted for exercising policy activity across each of the plurality of client computers or server computers utilizing the response; and re-evaluating applications currently executing against the updated policy file.

5. The method of claims 1, 2, and 3 wherein the application identifier is in the application access request.

6. The method of claims 1, 2, and 3 wherein the method is performed on a client computer on which the application is executing.

7. A computer program system comprising: a computer system file filter driver; computer system data store, computer system control agent, computer system policy service, server data store, server policy service, web application service, business logic manager, data access manager and data presentation manager coupled together as a system.

8. The computer system of claim 7, wherein the file filter driver comprises logic that intercepts requests to access the file system in the client computer operating system and tracks and records all file activities that relate to that access.

9. The computer system of claim 7, wherein the computer system data store comprises logic that maintains persistent data availability and caches information in the internal memory of the client computer.

10. The computer system of claim 7, wherein the computer system control agent and server policy service comprise (a) logic that communicates the results of policy and (b) logic that provides a means for the creation and further approval or denial of policy exception requests.

11. The computer system of claim 7, wherein the computer system policy service comprises logic that (a) observes intercepted file system access, (b) evaluates policy, (c) directs the behavior of the file filter system driver, and (d) communicates with the server.

12. The computer system of claim 7, wherein the server data store comprises logic that maintains persistent data availability and caches information in the internal memory of the server computer.

13. The computer system of claim 7, wherein the server policy service comprises logic that (a) manages modification and synchronization of policy across the plurality of client computers or across a subset of the plurality of client computers, (b) manages and maintains the status of system file filter drivers, control agents, and computer system policy services across the plurality of client computers or across a subset of the plurality of client computers, and (c) manages the deployment and installation of system file filter drivers, control agents, and computer system policy services across the plurality of client computers or across a subset of the plurality of client computers.

14. The computer system of claim 7, wherein the web application service comprises logic that (a) provides a secure channel of communication, and (b) data access layer.

15. The computer system of claim 7, wherein the business logic manager comprises logic that (a) authenticates entities responsible for processing delegated policy exceptions, (b) manages the presentation of administrative interfaces to the system, and (c) validates administrative activity against policy.

16. The computer system of claim 7, wherein the presentation manager comprises logic that displays the interface that administrators use to configure and monitor the solution.

17. The computer system of claim 7, wherein the application policy data structure comprises: an application identifier field containing data identifying an application that is attempting to execute and/or write executable code to disk and identifier fields containing data identifying the entity that is accessing the application identified by the application identifier field.

18. The method of claim 17, wherein the entity is selected from the role consisting of users and client computers.

19. The method of claim 17, wherein the application identifier is selected from the group of files containing identifying information of the file.
